(19) United States
(12) Patent Application Publication
(10) Pub. No.: US 2012/0263553 A1
(43) Pub. Date: Oct. 18, 2012

(54) WEDGE ANCHOR HAVING FEMALE THREADS AND TIGHTENING NUT

(75) Inventor: ELLIOTT GREENFIELD, ELKINS PARK, PA (US)

(73) Assignee: GREENFIELD MFG CO INC, PHILADELPHIA, PA (US)

(21) Appl. No.: 13/088,309

(22) Filed: Apr. 15, 2011

(51) Int. Cl. F16B 13/06

(52) U.S. Cl. 411/55

(57) ABSTRACT

The present invention relates to a captive wedge acting fastening device with a female thread and method for inserting said device into a hole in masonry, concrete, stone, or other aggregate materials while it is attached to a fastener or hanger without rotating said hanger or fastener.

### BACKGROUND OF INVENTION

Construction often requires the fastening of hangers for pipe or other things to concrete or masonry ceilings. Adapting to hanger rods or bolts without having to rotate these with the insertion of the hanger as with threaded concrete devices is impossible with most currently available devices. This devise enables that to be accomplished in a unique way.

### BACKGROUND ART

Seetaram in U.S. Pat. No. 3,709,089 teaches a female threaded portion in his FIG. 8, but fails to allow for the ability to tighten the anchor with an independent threaded portion. This fails to permanently affix the anchor to the masonry. Tsai in U.S. Pat. No. 6,457,922 teaches in FIG. 8 a plug type anchor which requires the threaded portion of the anchor or any attachment there to be rotated for installation.

### SUMMARY OF THE INVENTION

The invention is a wedge anchor with a female thread and an entrapped nut that enables the anchor to be affixed to masonry without the need to rotate the anchor.

This device enables threaded rod to be directly attached to the anchor itself after it is installed without the need for a coupling nut. The use of the coupling nut would allow for a possible mismatched thread length engagement which if left undetected would allow for failure in the threaded connection. Because the female threaded component is a permanent part of this anchor this will never happen if the rod is fully engaged in the anchor. By having a permanently fixed female section, the diameters of the anchor hole and the engaging rod may be of different diameters making the hole drilling easier with hand held tools.

A useful advantage of this device is that as the nut is tightened into the hole it pulls the wedge. Any additional forces applied to the anchor are not transmitted to the masonry until the stress on the nut are first overcome allowing for a lower cyclic strain on the masonry. This results in a longer life to the anchorage.

### DETAILED DESCRIPTION OF THE INVENTION

As seen in FIG. 1 inserting the wedge bolt in to a predrilled hole engages the ring device item 4 on wedge bolt 1 which holds the device in the hole. Tightening nut (2) by rotating it clockwise secures the wedge bolt into the hole. Item 3 the female threaded section may then hold a hanger as shown in FIG. 3.

### BRIEF DESCRIPTION OF THE DRAWINGS

FIG. 1a shows the principal embodiment of the invention.

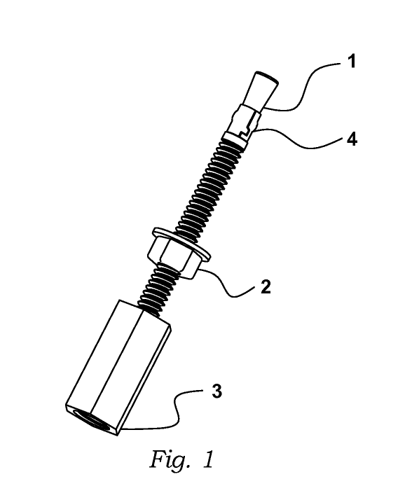

FIG. 2 shows a round shaped version

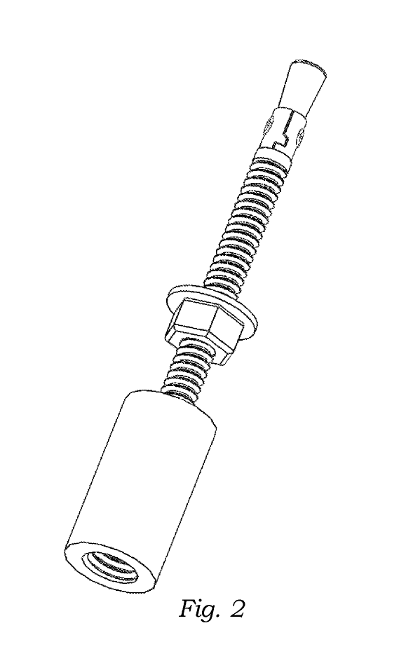

FIG. 3 shows a cross section of the hanger bolt

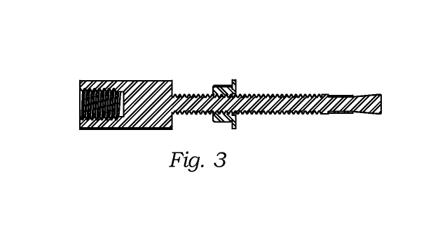

FIG. 4 shows the application of the hanger bolt with a pipe hanger attached.

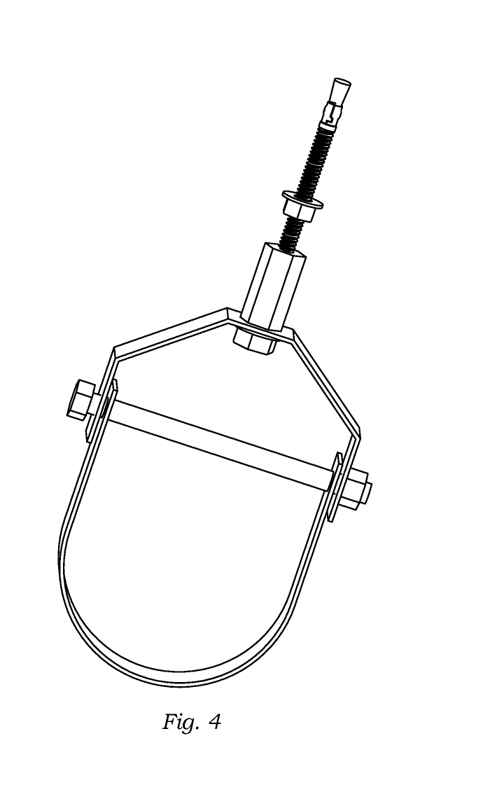

What is claimed is:

1. A metal wedge anchor as described in U.S. Pat. No. 3,766,819 Giannuzzi, U.S. Pat. No. 3,709,089 Seetaram, or U.S. Pat. No. 3,750,526 Lerich, to which is attached a tightening nut with or without a washer and a round or polygonal shaped section means which is longitudinally, fixedly attached to said anchor and contains a female receptacle which is threaded to receive a threaded rod or threaded fastener and the method of application of the anchor by placing said anchor means into a predrilled hole and tightening the nut to affix said anchor without rotating said anchor or any appliances thereto attached to it.
